(19) United States
(12) Patent Application Publication
(10) Pub. No.: US 2004/0035925 A1
(43) Pub. Date: Feb. 26, 2004

(54) Personal identification system based on the reading of multiple one-dimensional barcodes scanned from PDA/cell phone screen

(76) Inventors: Quen-Zong Wu, Yang-Mei (TW); Yuang-Tzong Lan, Yang-Mei (TW); Da-Wei Jain, Yang-Mei (TW)

Correspondence Address: RABIN & BERDO, P.C., Suite 500, 1101 14th Street, Washington, DC, 20005, US

(21) Appl. No.: 10/225,183

(22) Filed: Aug. 22, 2002

(51) Int. Cl. G06K 5/00

(52) U.S. Cl. 235/380

(57) ABSTRACT

A personal identification system based on the reading of multiple one-dimensional barcodes scanned from PDA/cell phone screen, which is a personal identification system applicable for reading multiple one-dimensional barcode on PDA/cell phone screen, comprises a multiple one-dimensional barcode generating system and a reading system of multiple one-dimensional barcode on PDA/cell phone screen, wherein said multiple one-dimensional barcode generating system is consisted of a data input unit and a barcode generating unit. The reading system of multiple one-dimensional barcode on PDA/cell phone screen is consisted of a PDA/cell phone reaction unit, a CCD camera, a frame grabber, an image processing unit, a barcode recognition unit and a data recording unit. The personal identification system based on the reading of multiple one-dimensional barcodes scanned from PDA/cell phone screen is useful as the mechanism for personal identification, certificates of purchase or checkoff.

### BACKGROUND OF THE INVENTION

1. Field of the Invention

The invention relates to a personal identification system based on the reading of multiple one-dimensional barcodes scanned from PDA or cell phone screen, and particular, to a barcode generating system for multiple one-dimensional barcodes and to a reading system applicable on PDA/cell phone screen or other liquid crystal display. Accordingly, the invention comprises a multiple one-dimensional barcode generating system and a multiple one-dimensional barcode reading system applicable on PDA/cell phone screen, which are useful as the mechanism for personal identification, purchase certificates or checkoff.

2. Description of the Prior Art

Current barcode is commonly based on emitting a laser from a laser emitting diode onto an objective and reading of the reflected wave therefrom. Unfortunately, this technology is not useful for reading barcode displayed on PDA/cell phone screen. Furthermore, due to the limitation of the size of PDA/cell phone screen, current one-dimensional barcode is not completely suitable for displaying on a PDA/cell phone screen, which becomes a disadvantage that makes the current barcode identification system unable to be used on a PDA/cell phone screen.

Accordingly, the above-said prior art technology has still many disadvantages and is not of perfect design, which needs to improve immediately.

In view of those disadvantages associated with the above-mentioned prior art technology, the inventor devotes to improve and create therefore, and after an intensive study for many years, has developed successfully a personal identification system based on the reading of multiple one-dimensional barcodes scanned from PDA or cell phone screen, and thus accomplished the present invention.

### SUMMARY OF THE INVENTION

Accordingly, one object of the invention is to provide a personal identification system based on the reading of multiple one-dimensional barcodes scanned from PDA or cell phone screen, which can supplement the current technology, and is useful as the mechanism for personal identification, certificates of purchase or check off.

Another object of the invention is to provide a personal identification system based on the reading of multiple one-dimensional barcodes scanned from PDA or cell phone screen, characterized in that a multiple one-dimensional barcode can be generated for being downloaded by the user as required by the practical demand, and that the multiple one-dimensional barcode on the PDA/cell phone screen can be transformed into a format of image, and the multiple one-dimensional barcode can be then identified by means of an image processing technique, and/or the resulted outcome can be stored.

The personal identification system based on the reading of multiple one-dimensional barcodes scanned from PDA or cell phone screen that can achieved the above-mentioned objects of the invention consists essentially of two subsystems, a multiple one-dimensional barcode generating system and a reading system of multiple one-dimensional barcodes on PDA/cell phone screen, wherein said multiple one-dimensional barcode generating system is consisted of a data input unit and a barcode generating unit. The data input unit can be used to input data by an administer. Thereafter, these data are transmitted to the barcode generating unit where a one-dimensional barcode is or multiple one-dimensional barcode are created correspondingly based on these original data and the practical demand. These multiple one-dimensional barcodes can be downloaded by authorized users through wireless network or internet. The format of multiple one-dimensional barcode is defined and extended on the base of the current format of one-dimensional barcode.

The reading system of multiple one-dimensional barcodes on PDA/cell phone screen is based centrally on image processing/identification technology and is consisted of a PDA/cell phone reaction unit, a CCD camera, a frame grabber, an image processing unit, a barcode recognition unit and a data recording unit. The PDA/cell phone reaction unit is responsible for detecting the PDA/cell phone entered into the detection area, and sending the detected signal to the frame grabber in order to trigger the CCD camera for taking the image on the PDA/cell phone screen. The multiple one-dimensional barcode image taken by the CCD camera from the PDA/cell phone screen is processed by the image processing unit by means of moving average method that transforms the barcode image into a binary image through a dynamic threshold value and removes impurity to remain the main image of the barcode. Thereafter, the barcode recognition unit decodes and recognizes completely the multiple one-dimensional barcodes.

The data recording unit backups the outcome from the barcode recognition unit in a log file and meanwhile, stores the barcode image in a image file. The content of the log file comprises the serial number, embedded barcode information, recording time and the backup image filename. If, after several trials, the barcode recognition unit can not decode barcode images on the PDA/cell phone, the data recording unit allows the user to key in barcode data through a keyboard, whereas the data recording unit can record the serial number, barcode data and recording time of the data in the log file.

### BRIEF DESCRIPTION OF THE DRAWINGS

The drawings disclose an illustrative embodiment of the present invention which serves to exemplify the various advantages and objects hereof, and are as follows:

FIG. 1 is a flow chart showing the use of a personal identification system based on the reading of multiple one-dimensional barcodes scanned from PDA/cell phone screen according to the invention;

FIG. 2 is a flow chart showing the use of the multiple one-dimensional barcode generating unit in the personal identification system based on the reading of multiple one-dimensional barcodes scanned from PDA/cell phone screen according to the invention;

FIG. 3 shows an embodiment of a multiple one-dimensional barcode image in the personal identification system based on the reading of multiple one-dimensional barcodes scanned from PDA/cell phone screen according to the invention;

FIG. 4 is a diagram showing the taking of the image on the PDA/cell phone screen by the CCD camera of the personal identification system based on the reading of multiple one-dimensional barcodes scanned from PDA/cell phone screen according to the invention;

FIG. 5 is a flow chart showing the use of the image processing unit in the personal identification system based on the reading of multiple one-dimensional barcodes scanned from PDA/cell phone screen according to the invention;

FIG. 6 is a flow chart showing the use of the barcode recognition unit in the personal identification system based on the reading of multiple one-dimensional barcodes scanned from PDA/cell phone screen according to the invention;

FIG. 7 shows an embodiment of a binary image on the PDA/cell phone screen in the personal identification system based on the reading of multiple one-dimensional barcodes scanned from PDA/cell phone screen according to the invention;

FIG. 8 shows an embodiment of a multiple one-dimensional barcode image recorded by the data recording unit in the personal identification system based on the reading of multiple one-dimensional barcodes scanned from PDA/cell phone screen according to the invention;

FIG. 9 shows an embodiment of the content of the log file recorded by the data recording unit in the personal identification system based on the reading of multiple one-dimensional barcodes scanned from PDA/cell phone screen according to the invention.

### DETAILED DESCRIPTION OF THE PREFERRED EMBODIMENT

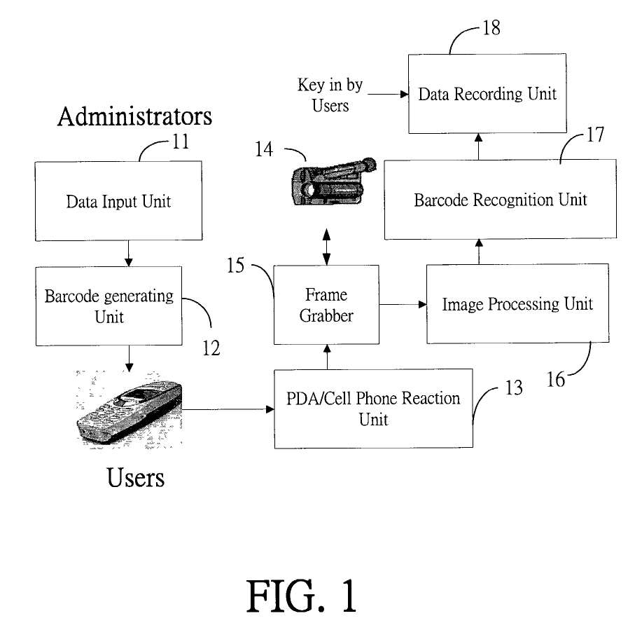

Referring to FIG. 1, a flow chart showing the use of a personal identification system based on the reading of multiple one-dimensional barcodes scanned from PDA/cell phone screen according to the invention, in which the identification system comprises a data input unit 11, a barcode generating unit 12, a PDA/cell phone reaction unit 13, a CCD camera 14, a frame grabber 15, a image processing unit 16, a barcode recognition unit 17 and a data recording unit 18. The barcode generating unit 12 creates a corresponding one-dimensional barcode or multiple one-dimensional barcode based on the data given by the data input unit 11. Such one-dimensional barcode or multiple one-dimensional barcode can be downloaded by the authorized user through wireless communication or computer network. After being downloaded to the PDA/cell phone, these barcodes are used as personal identification, certificates of purchase or check off. The PDA/cell phone reaction unit 13 is responsible for detecting the PDA/cell phone entering the reaction area and transmits a detecting signal to the frame grabber 15 such that the CCD camera 14 is triggered to take the image on the PDA/cell phone screen. Such PDA/cell phone reaction unit 13 can be a hardware such as a sensor or a software such as a image detecting means that can be used to sense whether a PDA/cell phone is present in its reaction area. When PDA/cell phone enters the reaction area, the state change thus detected can trigger the frame grabber 15 which can inform the CCD camera 14 to take the image on the PDA/cell phone screen. The image thus captured will be then processed by the image processing unit 16 where a binary image is created. This binary image will be transmitted to and be recognized by the barcode recognition unit 17. Thereafter, based on the outcome given by the barcode recognition unit 17, the data recording unit 18 will record in a log file the serial number, the embedded barcode information, the recording time and backup image filename. Meanwhile, the data recording unit can backup also barcode-containing images on the PDA/cell phone screen for further reference. If, after a number of trials, the barcode recognition unit 17 can not recognize accurately the barcode images on the PDA/cell phone screen, the data recording unit 18 can allow the user to key in barcode data through a keyboard, and meanwhile, the data recording unit 18 can backup the serial number, the barcode information and the recording time in a log file.

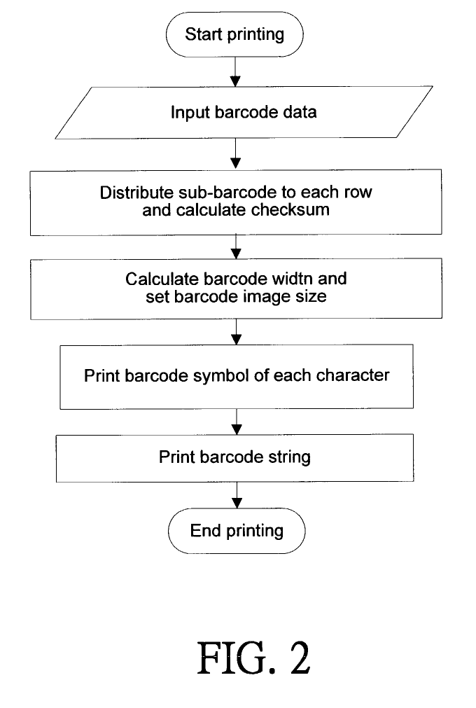

FIG. 2 shows a flow chart of the multiple one-dimensional barcode generating unit. After receiving the original information of the barcode, the barcode generating unit will separate equally the whole barcode string in every row according to the row number of multiple one-dimensional barcode practically required and calculate the checksum as well as calculate the width of the barcode and the required pixels of the barcode image. After completing this pre-process, the unit will translate each character of the sub-barcode into barcode symbols and print in an image. At last, if necessary, the unit will print the original barcode string at just beneath the position of the barcode in the image.

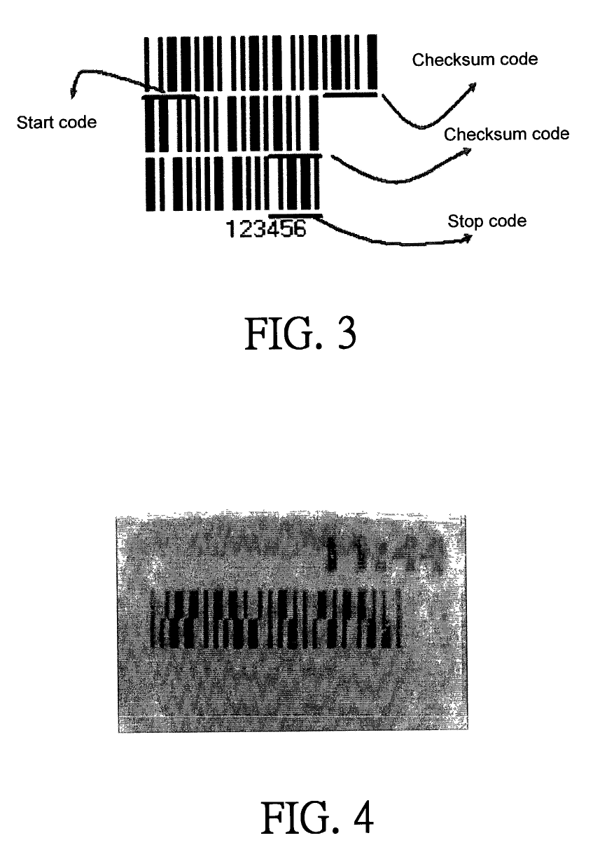

FIG. 3 shows an illustrative example of a multiple one-dimensional barcode image. This embodiment is implemented on the base of a code-39 format while extends to a format of multiple one-dimensional barcode. The first character of the first row in this multiple one-dimensional barcode is a start code, while the last character of the last row is a stop code. When the number of rows is one, the barcode conforms to a standard code-39 format, which starts at the start code and end at the stop code. Except the last character of the last row that is the stop code, the last character of the remanding rows in multiple one-dimensional barcode is a checksum which can prevent the barcode reading system from skipping some one row of the multiple one-dimensional barcode.

FIG. 4 shows an embodiment of the captured image on PDA/cell phone screen taken by the CCD camera. After taking the multiple one-dimensional barcode images on the PDA/cell phone screen, the frame grabber will get that image and transmit to the image processing unit for further processing.

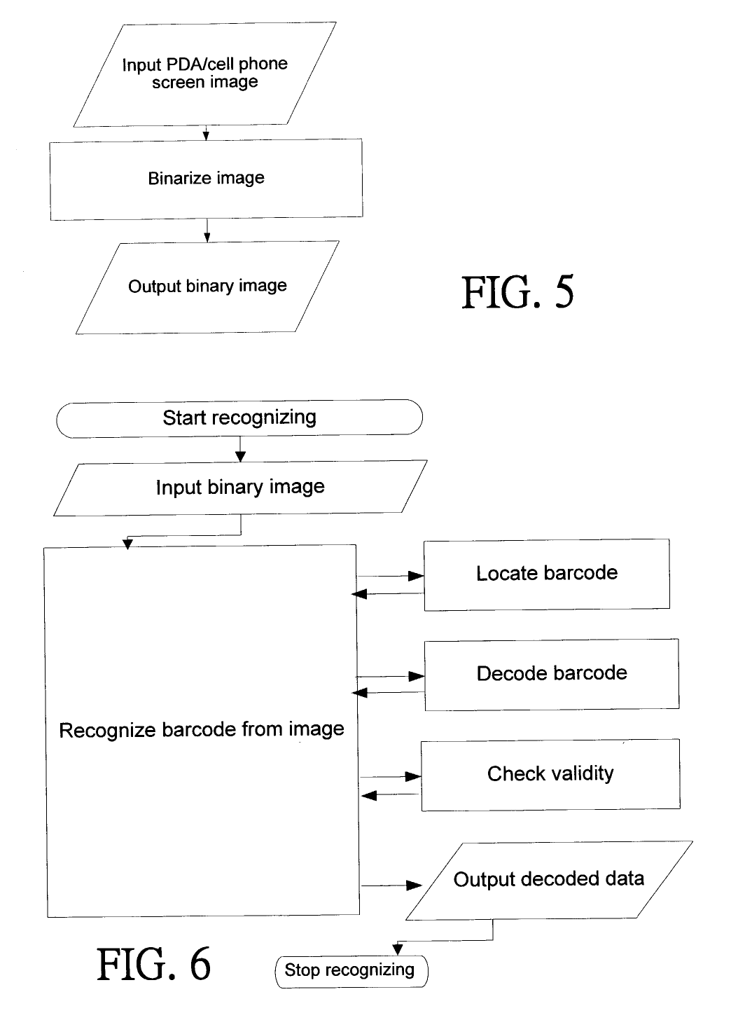

FIG. 5 is a flow chart showing the practical use of the image processing unit. After receiving the image on the PDA/cell phone screen captured by the CCD camera, the image is transformed into a binary image using moving average method with a dynamic threshold value, while removes the impurity and keeps the main image of the barcode to separate bar and space elements in the barcode image. The dynamic threshold value is determined by the equation

$${M}_{i + 1} = {M}_{i} + ( {g}_{i + 1} - {M}_{i} ) \times \frac{c}{width}$$

wherein Mᵢ₊₁ is the dynamic threshold of the pixel (i+1), gᵢ₊₁ is the gray value of the pixel (i+1), width is the image width and c is a constant.

FIG. 6 is a flow chart of the barcode recognition unit. At first, the binary barcode image is input and located by means of the Quiet Zone at both sides of the barcode as well as the characteristic property of pronounced gradient change of the barcode image. Then, the type of width is determined for every bar and space elements in the barcode. For example, in the format of code-39, every bar and space elements has just two type of width, i.e., broad and narrow. Next, on the basis of the definition of barcode format, the barcode symbol is transformed successively into the denoted word. The decoded result is checked with checksum which is embedded in the barcode. The correct recognition result is output, otherwise the system will discard that image.

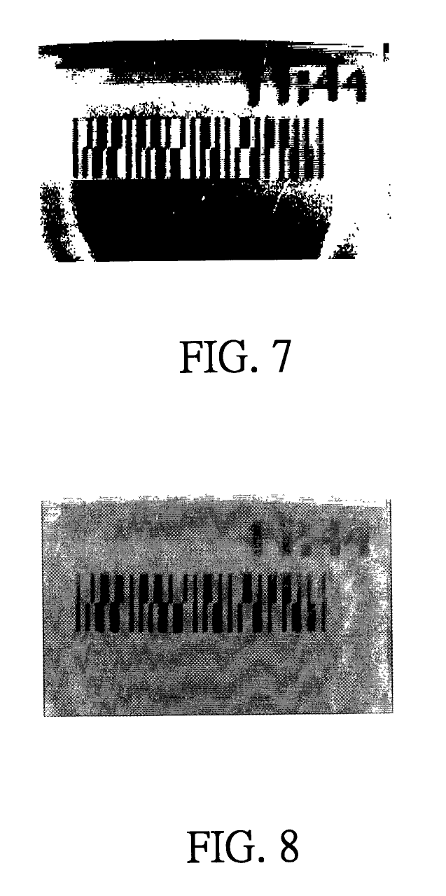

FIG. 7 shows an embodiment of a binary image obtained after processing the image on the PDA/cell phone screen. The image on the PDA/cell phone is transformed into a binary image using moving average method with a dynamic threshold value, while removes the impurity and keeps the main image of the barcode to separate bar and space elements in the barcode image.

FIG. 8 shows an embodiment of the multiple one-dimensional barcode image on the PDA/cell phone screen recorded in the data recording unit. The data recording unit records the image for future reference when the barcode recognition unit recognizes the image on the PDA/cell phone screen.

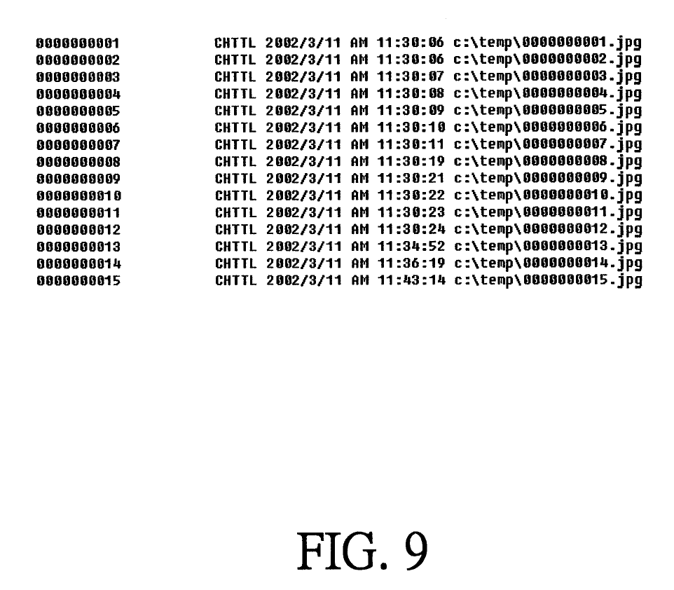

FIG. 9 shows an embodiment of the content of a log file recorded by the data recording unit. When the barcode recognition unit recognizes the multiple one-dimensional barcode on the PDA/cell phone screen, the data recording unit will record related data in a log file and at the same time backups the barcode image on the PDA/cell phone screen. The content of the log file comprises a serial number, the embedded barcode information, the recording time and the backup barcode image filename for each data.

The personal identification system based on the reading of multiple one-dimensional barcodes scanned from PDA or cell phone screen according to the invention has several following advantages over the above-recited reference and other conventional technique:

(1) Mass production of multiple one-dimensional barcodes is feasible and recognition of different number of rows can be accomplished readily.

(2) The present system can read, while other conventional techniques fail to read, images on the PDA/cell phone screen or other liquid crystal displays.

(3) By combining image processing and recognition techniques, a variety of barcodes can be read extensively, and will not be restricted in just reading multiple one-dimensional barcode.

(4) By taking image to be recognized with a CCD camera, risk of radiation hazard on the human body can be reduced.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A personal identification system based on the reading of multiple one-dimensional barcodes scanned from PDA/cell phone screen, comprises a multiple one-dimensional barcode generating system and a reading system of multiple one-dimensional barcode on PDA/cell phone screen, wherein said multiple one-dimensional barcode generating system is consisted of a data input unit and a barcode generating unit, wherein said data input unit can be used to input the original data of said barcode and then said original data are transmitted to said barcode generating unit where a corresponding barcode is created;
the reading system of multiple one-dimensional barcode on PDA/cell phone screen is based centrally on image processing/identification technology and is consisted of a PDA/cell phone reaction unit, a CCD camera, a frame grabber, an image processing unit, a barcode recognition unit and a data recording unit, wherein said PDA/cell phone reaction unit is responsible for detecting the PDA/cell phone entered into the detection area, and sending the detected signal to the frame grabber in order to trigger the CCD camera for taking the image on the PDA/cell phone screen; said multiple one-dimensional barcode image taken by said CCD camera from said PDA/cell phone screen is processed by said image processing unit into a binary image which is recognized completely by said barcode recognition unit decodes and the result recognized is backup in said data recording unit.

2. A personal identification system based on the reading of multiple one-dimensional barcodes scanned from PDA/cell phone screen as recited in claim 1, characterized in that said barcode generating unit in said multiple one-dimensional barcode generating system can generate a one-dimensional barcode or a multiple one-dimensional barcode as required.

3. A personal identification system based on the reading of multiple one-dimensional barcodes scanned from PDA/cell phone screen as recited in claim 2, characterized in that said multiple one-dimensional barcode generated by said barcode generating unit in said multiple one-dimensional barcode generating system incorporates a checksum.

4. A personal identification system based on the reading of multiple one-dimensional barcodes scanned from PDA/cell phone screen as recited in claim 1, characterized in that said reading system of multiple one-dimensional barcodes scanned from PDA/cell phone screen can recognize the barcode scanned from a PDA/cell phone screen or from other liquid crystal display.

5. A personal identification system based on the reading of multiple one-dimensional barcodes scanned from PDA/cell phone screen as recited in claim 1, characterized in that said PDA/cell phone reaction unit of said reading system of multiple one-dimensional barcodes scanned from PDA/cell phone screen senses by means of a sensor hardware or a image detecting manner as a software.

6. A personal identification system based on the reading of multiple one-dimensional barcodes scanned from PDA/cell phone screen as recited in claim 1, characterized in that said image processing unit of said reading system of multiple one-dimensional barcodes scanned from PDA/cell phone screen transforms the barcode image into a binary image using a moving average method with a dynamic threshold value and removes impurity to remain the main image of the barcode.

7. A personal identification system based on the reading of multiple one-dimensional barcodes scanned from PDA/cell phone screen as recited in claim 1, characterized in that said reading system of multiple one-dimensional barcodes scanned from PDA/cell phone screen locates the position of said barcode by means of Quiet Zone on both sides of said barcode as well as the characteristic property of the pronounced gradient change of said barcode image.

8. A personal identification system based on the reading of multiple one-dimensional barcodes scanned from PDA/cell phone screen as recited in claim 1, characterized in that said barcode recognition unit of said reading system of multiple one-dimensional barcodes scanned from PDA/cell phone screen checks the decoded result with the checksum of said barcode.

9. A personal identification system based on the reading of multiple one-dimensional barcodes scanned from PDA/cell phone screen as recited in claim 8, characterized in that said image processing unit of said reading system of multiple one-dimensional barcodes scanned from PDA/cell phone screen will discard the image if the recognized result is not correct, and will feedback a signal for taking image again.

10. A personal identification system based on the reading of multiple one-dimensional barcodes scanned from PDA/cell phone screen as recited in claim 1, characterized in that said data recording unit of said reading system of multiple one-dimensional barcodes scanned from PDA/cell phone screen will record the serial number, the embedded barcode information, the recording time and the backup image filename.

11. A personal identification system based on the reading of multiple one-dimensional barcodes scanned from PDA/cell phone screen as recited in claim 1, characterized in that said data recording unit of said reading system of multiple one-dimensional barcodes scanned from PDA/cell phone screen can provide manual barcode data input.
